(19) United States
(12) Patent Application Publication
(10) Pub. No.: US 2009/0247406 A1
(43) Pub. Date: Oct. 1, 2009

(54) Encapsulated Luminescent Pigments

(76) Inventors: David De Corte, Arlesheim (CH); Mara Destro, Bologna (IT); Cesare Lorenzetti, Grottammare (IT); Kishor Kumar Mistry, West Yorkshire (GB); Michael Tinkl, Eiken (CH); Marcello Vitale, Castel d'Aiano (IT)

Correspondence Address: JoAnn Villamizar;Ciba Corporation/Patent Department, 540 White Plains Road, P.O. Box 2005, Tarrytown, NY, 10591, US

(21) Appl. No.: 12/083,318

(22) PCT Filed: Oct. 4, 2006
(86) PCT No.: PCT/EP2006/067037

§ 371 Date: Apr. 9, 2008

(30) Foreign Application Priority Data
Oct. 12, 2005 (EP) 05109465.4

(51) Int. Cl. A01N 25/28; B32B 27/00; A01P 21/00

(52) U.S. Cl. 504/189; 252/301.35; 428/220; 428/339

(57) ABSTRACT

The instant invention relates to encapsulated luminescent pigments, which are encapsulated by a polymeric shell. Further aspects of the invention are polymeric compositions containing these encapsulated luminescent pigments and their use in electronic devices and agricultural films.

The instant invention relates to encapsulated luminescent pigments, which are encapsulated by a polymeric shell. Further aspects of the invention are polymeric compositions containing these encapsulated luminescent pigments and their use in electronic devices and agricultural films.

Luminescent pigments are often photochemically instable and readily degrade under actinic radiation, thereby loosing their luminescent property. For this reason, luminescent pigments have only limited use in outdoor applications where they are exposed to sunlight and rain. Although there are a variety of potential outdoor application areas for luminescent pigments, they have been rarely realized so far, because of the limited light stability and hence limited life time.

Potential outdoor application areas for luminescent pigments are, for example, electronic applications, such as solar cells, where luminescent pigments can act as radiation converters, thereby improving the efficiency of the solar cell. Another possible application is the use in coatings, for example, for road signs, improving the contrast and visibility of the sign.

One of the most promising application areas for luminescent pigments is in agricultural films, for example for greenhouses, where they can act as radiation converter and enhance plant growths.

Plants use light, both as a source of energy and as a signal to direct their growth. Light, used for energy, is that falling within the PAR, Photosynthetically Active Radiation region, which is defined as all photons between 400 and 700 nm. One of the most important and best known light measures used by plants to regulate their growth is the ratio of Red (600-700 nm) to Far Red (700-800 nm). Many attempts have been made to impact positively these radiation inputs to plant growth by manipulating natural light passing through coverings, such as those employed in greenhouses and tunnels, or reflected by mulching sheets. One straightforward strategy is the transformation of ultraviolet light, which is not absorbed by plants, and, therefore, does not enter their energy cycle into red light, which belongs to the PAR region and affects the Red/Far Red ratio.

Especially suitable is the luminescent pigment described in EP1413599 as one component of a thermoplastic polymer composition. Yet, problems remain which are addressed by the present invention.

Luminescent pigments are affected by incorporation in the thermoplastic polymer so that their emission efficiency, which can be described as the number of photons emitted divided by the number of photons absorbed, is reduced due to wasteful interactions with other components of the composition. Moreover also, the stability of the pigments is reduced by processes due to matrix incorporation, so that luminescence decreases with time. Finally, pigments dispersed in a thermoplastic polymeric matrix reduce PAR transmission, thereby reducing energy inputs for plants.

Surprisingly it has been found that microencapsulation, when applied to luminescent pigments, which are, for example, used in thermoplastic polymer compositions to improve plant growth, increases their light conversion and emission efficiency, decreases their visible light absorption and reflection, which cause a decrease in PAR, and makes their luminescence effect last longer. The pigments are microencapsulated in a shell of continuous polymeric material, which does not form a covalent or ionic bond with the pigments surface, and maintains them separated from the thermoplastic polymeric composition.

Under microencapsulation of a luminescent pigment it is understood: providing a material, which forms a continuous polymeric shell around the pigment, a shell which is not covalently or ionically bound to or otherwise in intimate contact with the luminescent pigment's surface.

One aspect of the invention is a microencapsulated luminescent pigment having an absorption maximum between 350 nm and 550 nm and an emission maximum between 550 nm and 700 nm with a Stokes shift equal or greater than 80 nm, wherein the shell of the microcapsule is formed from a crosslinked polymer. (Anspruch 1)

Preferred is a microencapsulated luminescent pigment wherein the absorption maximum is between 350 nm and 500 nm and the emission maximum is between 600 nm and 700 nm, in particular between 620 nm and 680 nm. (Anspruch 2)

It may be advantageous, if the emission extends partially in the range of 700 nm to 800 nm.

Preferably the Stokes shift is equal to or greater than 120 nm. (Anspruch 3)

Under the term luminescent it is understood both fluorescent and phosphorescent.

Suitable pigments include classical inorganic pigments such as those formed by a semiconducting medium doped with luminophores, such as lanthanides or other transition metals, including long-lasting phosphorescent materials, organometallic compounds, emissive metallic or semiconductor nanocrystals and organic fluorescent or phosphorescent pigments.

Lanthanide complexes with suitable optical properties, which can be microencapsulated according to the instant invention, are, for example, described in WO 99/27006 and WO 2000/24243. Typically the metal atom is Europium, Yttrium, Samarium, Terbium or Gadolinium or a mixture thereof. (Agrogaz Verbindungen)

Preferably the microencapsulated luminescent pigment is an organic luminescent pigment. (Anspruch 4)

For example the organic luminescent pigment is selected from the group consisting of anthraquinones, coumarins, benzocoumarins, xanthenes, benzo[a]xanthenes, benzo[b]xanthenes, benzo[c]xanthenes, phenoxazines, benzo[a]phenoxazines, benzo[b]phenoxazines and benzo[c]phenoxazines, napthalimides, naphtholactams, azlactones, methines, oxazines and thiazines, diketopyrrolopyrroles, perylenes, quinacridones, benzoxanthenes, thio-epindolines, lactamimides, diphenylmaleimides, acetoacetamides, imidazothiazines, benzanthrones, perylenmonoimides, perylenes, phthalimides, benzotriazoles, pyrimidines, pyrazines, triazoles, dibenzofurans, triazines and barbituric acid derivatives. (Anspruch 5)

Examples of organic luminescent pigments are

### a) Xanthenes of Formula

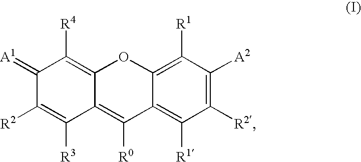

wherein A¹ represents O or N-Z in which Z is H or C₁-C₈alkyl, or is optionally combined with R², or R⁴ to form a 5- or 6-membered ring, or is combined with each of R² and R⁴ to form two fused 6-membered rings; A² represents —OH or —NZ₂; R¹, R^{1′}, R², R^{2′}, R³ and R⁴ are each independently selected from H, halogen, cyano, CF₃, C₁-C₈alkyl, C₁-C₈alkylthio, C₁-C₈alkoxy, aryl and heteroaryl; wherein the alkyl portions of any of R¹, R^{2′} or R¹ through R⁴ are optionally substituted with halogen, carboxy, sulfo, amino, mono- or dialkylamino, alkoxy, cyano, haloacetyl or hydroxy; and the aryl or heteroaryl portions of any of R¹, R^{2′} or R¹ through R⁴ are optionally substituted with from one to four substituents selected from the group consisting of halogen, cyano, carboxy, sulfo, hydroxy, amino, mono- or di(C₁-C₈)alkylamino, C₁-C₈alkyl, C₁-C₈alkylthio and C₁-C₈alkoxy; R⁰ is halogen, cyano, CF₃, C₁-C₈alkyl, C₁-C₈alkenyl, C₁-C₈alkynyl, aryl or heteroaryl having the formula:

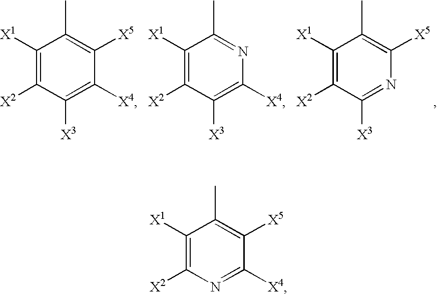

wherein X¹, X², X³, X⁴ and X⁵ are each independently selected from the group consisting of H, halogen, cyano, CF₃, C₁-C₈alkyl, C₁-C₈alkoxy, C₁-C₈alkylthio, C₁-C₈alkenyl, C₁-C₈alkynyl, SO₃H and CO₂H. Additionally, the alkyl portions of any of X¹ through X⁵ can be further substituted with halogen, carboxy, sulfo, amino, mono- or dialkylamino, alkoxy, cyano, haloacetyl or hydroxy. Optionally, any two adjacent substituents X¹ through X⁵ can be taken together to form a fused aromatic ring that is optionally further substituted with from one to four substituents selected from halogen, cyano, carboxy, sulfo, hydroxy, amino, mono- or di(C₁-C₈) alkylamino, (C₁-C₈)alkyl, (C₁-C₈)alkylthio and (C₁-C₈)alkoxy.

In certain embodiments, the xanthene colorants of formula I (as well as other formulae herein) will be present in isomeric or tautomeric forms which are included in this invention.

b) Benzo[a]xanthens of Formula

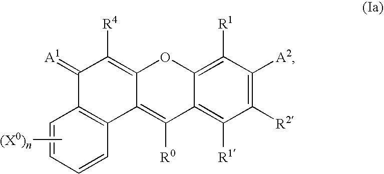

wherein
n is an integer of 0 to 4,
each X⁰ is independently selected from the group consisting of H, halogen, cyano, CF₃, C₁-C₈alkyl, C₁-C₈alkoxy, C₁-C₈alkylthio, C₁-C₈alkenyl, C₁-C₈alkynyl, aryl, heteroaryl, SO₃H and CO₂H;
A¹, A², R⁰, R¹, R^{1′}, R^{2′}, and R⁴ are as defined above, wherein the alkyl portions of X⁰ can be further substituted with halogen, carboxy, sulfo, amino, mono- or dialkylamino, alkoxy, cyano, haloacetyl or hydroxy, and the aryl or heteroaryl portions of any of R¹, R^{1′}, R^{2′}, and R⁴ are optionally substituted with from one to four substituents selected from the group consisting of halogen, cyano, carboxy, sulfo, hydroxy, amino, mono- or di(C₁-C₈)alkylamino, C₁-C₈alkyl, C₁-C₈alkylthio and C₁-C₈alkoxy.
c) Benzo[b]xanthens of Formula

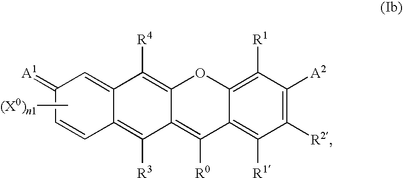

wherein
n1 is an integer of 0 to 3, X⁰, A¹, A², R⁰, R¹, R^{1′}, R^{2′}, R³ and R⁴ are as defined above.
d) Benzo[b]xanthens of Formula

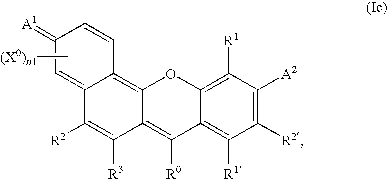

wherein
n1 is an integer of 0 to 3, X⁰, A¹, A², R⁰, R¹, R^{1′}, R^{2′}, R² and R³ are as defined above.

### e) Coumarins of Formula

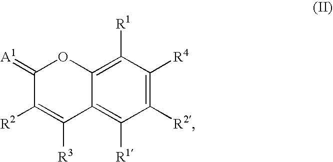

wherein A¹, R¹, R^{1′}, R^{2′}, R², R³ and R⁴ are as defined above.

In certain embodiments R² and R³ are independently of each other of halogen, cyano, CF₃, C₁-C₈alkyl, aryl, or heteroaryl having the formula

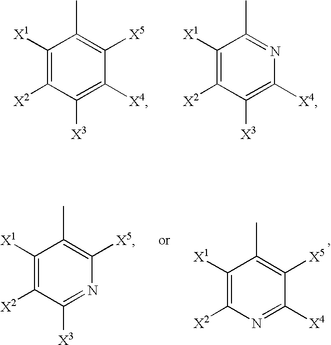

wherein X¹, X², X³, X⁴ and X⁵ are as defined above.

The benzocoumarin series of pigments are those of formula II in which R² and R³ are combined to form a fused benzene ring, optionally substituted with one to four substituents selected from halogen cyano, carboxy, sulfo, hydroxy, amino, mono- or di(C₁-C₈)alkylamino, C₁-C₈alkyl, C₁-C₈alkylthio and C₁-C₈alkoxy.

### f) Phenoxazines of Formula

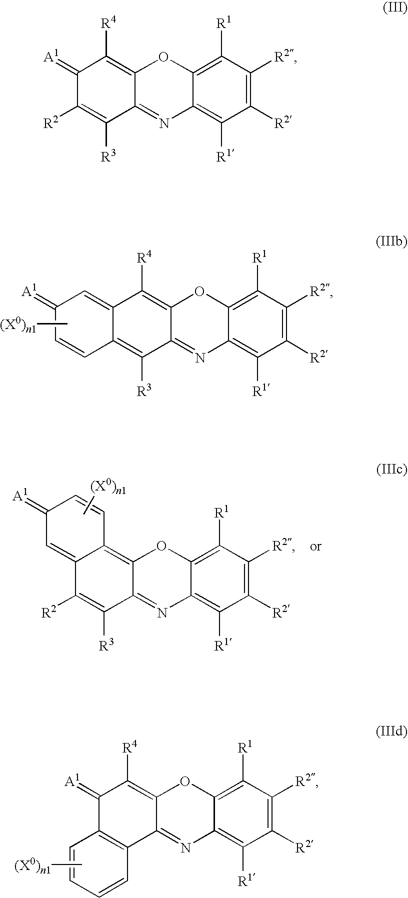

wherein R^{2″} has the meanings provided above for R^{2′}. Optionally A¹ can be combined with each of R² and R⁴ to form a five- or six-membered ring or can be combined with each of R² and R⁴ to form two fused six-membered rings, n1, X⁰, A¹, R¹, R^{1′}, R^{2′}, R², R³ and R⁴ are as defined above.

### g) Napthalimides

A very wide variety of naphthalimides are known, examples are:

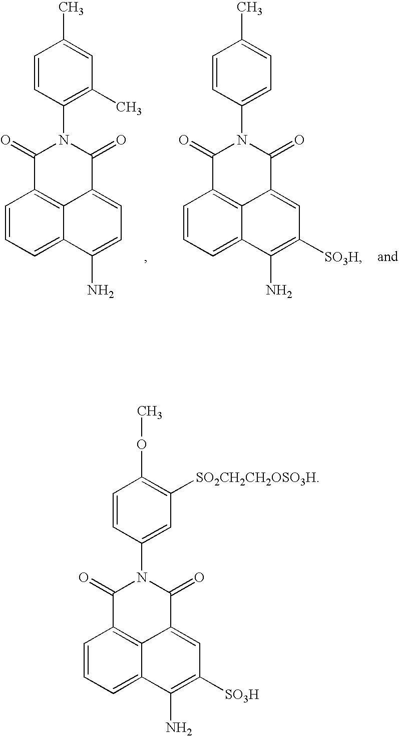

### h) Naphtholactams

Only a few important representative examples are shown below:

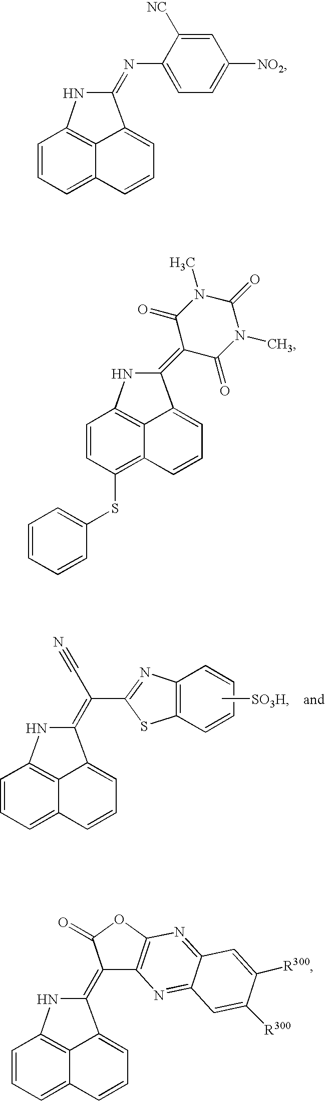

wherein R³⁰⁰ is H, C₁-C₈alkyl, or C₁-C₈alkoxy.

### i) Azlactones

Only a few important representative examples are shown below:

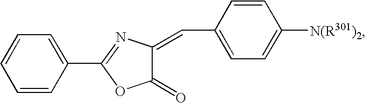

wherein R³⁰¹ is C₁-C₈alkyl.

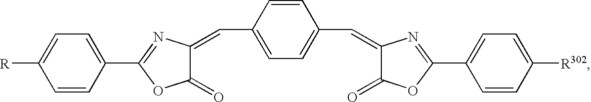

wherein R³⁰² is H, or methoxy.

### j) Methines

Only a few important representative examples are shown below:

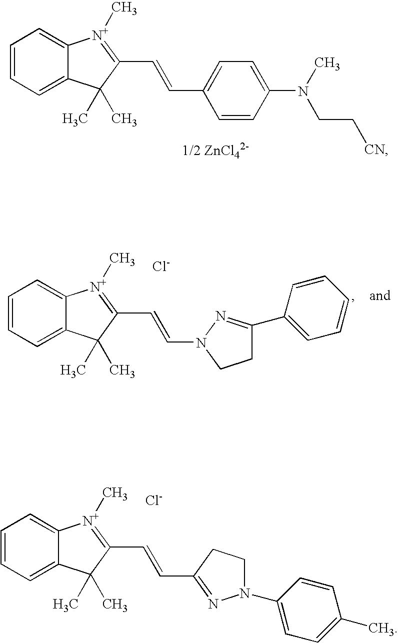

### k) Oxazines and Thiazines

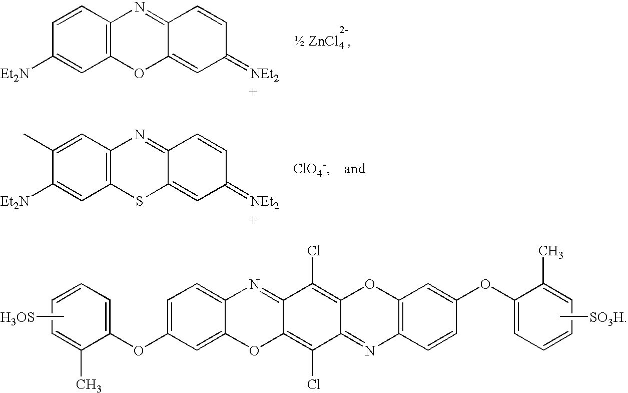

Suitable perylene and anthraquinone pigments are for example sold under the trade name Lumogene F pigments.

Another preferred pigment is the condensation product of

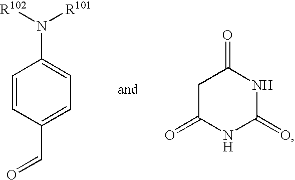

wherein R¹⁰¹ and R¹⁰² are independently hydrogen or C₁-C₁₈ alkyl, such as for example, methyl, ethyl, n-propyl, isopropyl, n-butyl, sec-butyl, isobutyl, tert-butyl, n-amyl, tert-amyl, hexyl, heptyl, octyl, 2-ethylhexyl, nonyl, decyl, dodecyl, tetradecyl, hexadecyl or octadecyl. Preferably R¹⁰¹ and R¹⁰² are methyl. The condensation product is of formula

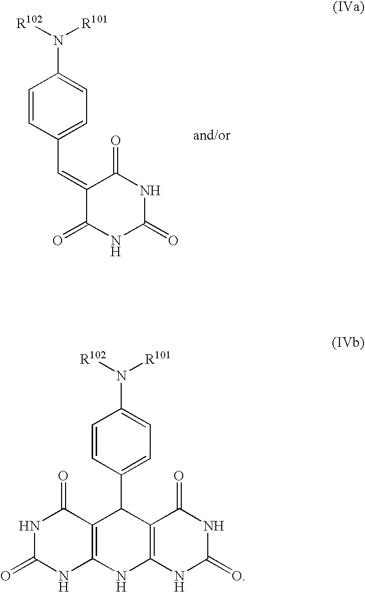

Preferred is a microencapsulated luminescent pigment wherein the luminescent pigment is selected from the group consisting of anthraquinones, oxazines, perylenes and barbituric acid derivatives. (Anspruch 6)

In particular the microencapsulated luminescent pigment is the condensation product of

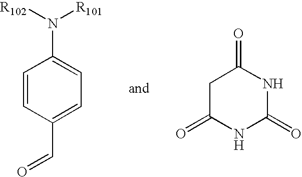

wherein R₁₀₁ and R₁₀₂ are independently hydrogen or C₁-C₁₈ alkyl. (Anspruch 7)

Most preferred is the condensation product of barbituric acid and para-dimethylamino benzaldehyde. The reaction and the products are known and have the following CAS numbers: (IVa) is No. 1753-47-5 and (IVb) is No. 152734-34-4. The condensation reaction is typically carried out in a solvent, such as for example ethanol. Depending on the amount of additional NH₄OH the formation of product (IVa) or (IVb) is favored. The condensation temperature range is typically from 30° C. to 100° C. The condensation is usually carried out at atmospheric pressure.

In principal all known microencapsulation techniques may be used, which lead to outer polymeric shell containing the luminescent pigment in the inner core.

Typical techniques for forming a polymer shell are described, for instance, in GB 1,275,712, 1,475,229 and 1,507,739, DE 3,545,803 and U.S. Pat. No. 3,591,090. Generally these processes employ a continuous aqueous phase into which the shell forming materials are dissolved.

In particular, microencapsulation processes suitable in the instant invention fall into three categories a) coacervation method, b) interfacial polymerization method and c) in-situ polymerization method. These methods can ideally accomplish the polymeric shell around the pigments. The microencapsulation processes form discrete microcapsules of a size comparable to that of the pigment or pigments enclosed. The pigments are microencapsulated in a shell of continuous polymeric material, which does not form a covalent or ionic bond with the pigments surface, and maintains them separated from the substrate.

The coacervation method utilizes the formation of an oil-in-water emulsion. The polymeric shell material is coacervated out of the aqueous medium and the polymer colloid deposited as capsule shell around the dispersed oily droplets through careful control of concentration, pH and temperature to form the microcapsules. Materials suitable for coacervation include gelatin and gum acacia as described in U.S. Pat. No. 2,800,457. WO9220441 describes encapsulated particles comprising a core surrounded by a coacervate coating that comprises a low critical solution temperature (LCST) polymer and a water removal depressant for the temperature of reversible insolubilisation of that polymer. The composition is made by forming a dispersion of the water insoluble core particles in a solution of the polymer, heating the solution to cause it to precipitate as a coacervate, and then adding the depressant. In this process the LCST wall building material coacervates from the exterior. To prevent the encapsulated particles of the invention coagulating and subsequently phase separating in the environment in which they are to be used, an entropic stabilising polymer, such as carboxymethyl cellulose, sodium alginates or starch, can be mixed with the LCST polymeric component prior to encapsulation.

The interfacial polymerization method depends on the reaction of two interfacial polymerisable monomers at the interface of an oil-in-water emulsion. Generally an oil soluble first monomer is dissolved in the disperse phase and a second water-soluble monomer is added to the aqueous phase. The monomers react by polycondensation reaction at the interface between the dispersed oily droplets and surrounding aqueous medium and forming a polymeric membrane around the oil droplets. Polymeric membranes formed are polyurea and polyurethane's as described in U.S. Pat. No. 3,429,827 and U.S. Pat. No. 4,428,978.

Processes of forming capsules involving in-situ polymerisation of amino resins are known. Generally aminoplast capsules are formed by distributing a water immiscible liquid in an aqueous liquid containing the aminoplast precursor, for instance a melamine formaldehyde resin. The capsule wall is formed by in-situ polymerisation of the amino resin prepolymer onto the droplets of water immiscible liquid. Thus the capsule wall is built up from the exterior by polycondensation of the prepolymer from the aqueous continuous phase. In situ polymerization is a well-known method and its principal features are already described in GB 1 507 739.

Preferably the crosslinked polymer of the shell is selected from the group consisting of melamine-formaldehydes, urea-formaldehydes, phenol-formaldehydes, polyamides, polyureas, polyurethane's, polyacrylates, polymethacrylates, polystyrenes, polyvinylpyridines, polyacrlonitriles, polyepoxides, gelatin, poly (vinyl alcohol), cellulose derivatives, silica's and silicone resins. (Anspruch 9)

Preferred is a microencapsulated luminescent pigment wherein the polymer of the shell is aminoplast formed by in situ polymerization. (Anspruch 8)

In particular the crosslinked polymer of the shell is selected from the group consisting of melamine-formaldehydes, urea-formaldehydes and phenol-formaldehydes. (Anspruch 10)

For example the crosslinked polymer of the shell is a melamine formaldehyde polymer.

For instance the crosslinked polymer of the shell is not a polyurethane polyurea resin.

Typically the microencapsulated luminescent pigment has an average particle size of 0.8 to 50, preferably from 0.8 to 20μ. (Anspruch 11)

Typically the wall thickness of the shell is from 20 nm to 2000 nm, preferably from 100 nm to 1000 nm.

For example the weight ratio of microcapsule-forming material to microencapsulated luminescent pigment is from 0.001:1 to 1:1. In many cases 0.01:1 to 0.5:1 is a good choice. (Anspruch 12)

It is also possible that the microencapsulated luminescent pigment additionally contains in the microcapsule a further additive selected from the group consisting of antioxidants, phosphites or phosphonites, UV-absorbers, light stabilizers, singlet oxygen quenchers, further fluorescent dyes or pigments, processing aids, antistatic agents, antifog additives and fillers or reinforcing materials. (Anspruch 13)

Examples for such additives are given later.

Another aspect of the instant invention is a polymer composition comprising

a) a thermoplastic, elastomeric or crosslinked polymer and
b) a microencapsulated luminescent pigment having an absorption maximum between 350 nm and 550 nm and an emission maximum between 550 nm and 700 nm with a Stokes shift equal or greater than 80 nm, wherein the shell of the microcapsule is formed from a crosslinked polymer. (Anspruch 14)

Examples of suitable thermoplastic, elastomeric or crosslinked polymers are given below.

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).
   2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).
   3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.
   4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).
6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.
6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.
6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).
6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.
8. Halogen-containing polymers such as polychloroprene, chlorinated rubbers, chlorinated and brominated copolymer of isobutylene-isoprene (halobutyl rubber), chlorinated or sulfo-chlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.
9. Polymers derived from α,β-unsaturated acids and derivatives thereof such as polyacrylates and polymethacrylates; polymethyl methacrylates, polyacrylamides and polyacrylonitriles, impact-modified with butyl acrylate.
10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.
11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.
12. Homopolymers and copolymers of cyclic ethers such as polyalkylene glycols, polyethylene oxide, polypropylene oxide or copolymers thereof with bisglycidyl ethers.
13. Polyacetals such as polyoxymethylene and those polyoxymethylenes which contain ethylene oxide as a comonomer; polyacetals modified with thermoplastic polyurethanes, acrylates or MBS.
14. Polyphenylene oxides and sulfides, and mixtures of polyphenylene oxides with styrene polymers or polyamides.
15. Polyurethanes derived from hydroxyl-terminated polyethers, polyesters or polybutadienes on the one hand and aliphatic or aromatic polyisocyanates on the other, as well as precursors thereof.
16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 416, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).
17. Polyureas, polyimides, polyamide-imides, polyetherimids, polyesterimids, polyhydantoins and polybenzimidazoles.
18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.
19. Polycarbonates and polyester carbonates.

### 20. Polyketones.

21. Polysulfones, polyether sulfones and polyether ketones.
22. Crosslinked polymers derived from aldehydes on the one hand and phenols, ureas and melamines on the other hand, such as phenol/formaldehyde resins, urea/formaldehyde resins and melamine/formaldehyde resins.
23. Drying and non-drying alkyd resins.
24. Unsaturated polyester resins derived from copolyesters of saturated and unsaturated dicarboxylic acids with polyhydric alcohols and vinyl compounds as crosslinking agents, and also halogen-containing modifications thereof of low flammability.
25. Crosslinkable acrylic resins derived from substituted acrylates, for example epoxy acrylates, urethane acrylates or polyester acrylates.
26. Alkyd resins, polyester resins and acrylate resins crosslinked with melamine resins, urea resins, isocyanates, isocyanurates, polyisocyanates or epoxy resins.
27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.
28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.
29. Blends of the aforementioned polymers (polyblends), for example PP/EPDM, Poly-amide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

Preferred is a polymer composition wherein component a) is a thermoplastic polymer. (Anspruch 15)

For instance the thermoplastic polymer is selected from the group consisting of a polyolefin, a polyester, a polyvinylalcohol, a polyvinylacetate and a polycarbonate. (Anspruch 16)

Preferably the polymer composition is in the form of a film with a thickness from 10μ to 300μ. (Anspruch 17)

In general it is preferred that the film is as transparent as possible.

In a specific embodiment the film is a multilayer construction of between 2 and 7 polymer layers containing component b) in at least 1 layer. (Anspruch 18)

In this case a polymer composition of the invention containing a relatively large amount of the microencapsulated luminescent pigment is applied in a thin layer (10-20μ) to a shaped article made from a polymer containing little or no microencapsulated luminescent pigment. Application can be made at the same time as the shaping of the base article, for example by coextrusion. Alternatively, application can be made to the base article after it has been shaped, for example by lamination with a film or by coating with a solution.

For instance the polymer composition can contain an additional additive selected from the group consisting of antioxidants, phosphites or phosphonites, UV-absorbers, light stabilizers, singlet oxygen quenchers, further fluorescent dyes or pigments, processing aids, antistatic agents, antifog additives and fillers or reinforcing materials. (Anspruch 19)

Examples for such additives, which may be in the microcapsule and or in the polymer substrate, are given below.

### 1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.
1.2. Alkylthiomethylphenols, for example 2,4-dioctylthiomethyl-6-tert-butylphenol, 2,4-dioctylthiomethyl-6-methyl phenol, 2,4-dioctylthiomethyl-6-ethylphenol, 2,6-di-dodecylthiomethyl-4-nonylphenol.
1.3. Hydroquinones and alkylated hydroquinones, for example 2,6-di-tert-butyl-4-methoxy-phenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.
1.4. Tocopherols, for example α-tocopherol, β-tocopherol, γ-tocopherol, δ-tocopherol and mixtures thereof (vitamin E).
1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)-disulfide.
1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butyl-phenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra-(5-tert-butyl-4-hydroxy-2-methylphenyl)pentane.
1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxy-benzyl)sulfide, isooctyl-3,5-di-tert-butyl-4-hydroxybenzylmercaptoacetate.
1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.
1.9. Aromatic hydroxybenzyl compounds, for example 1,3,5-tris(3,5-di-tert-butyl-4-hydroxy-benzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.
1.10. Triazine compounds, for example 2,4-bis(octylmercapto)-6-(3,5-di-tert-butyl-4-hydroxy-anilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxy-phenylpropionyl)-hexahydro-1,3,5-triazine, 1,3,5-tris(3,5-dicyclohexyl-4-hydroxybenzyl)isocyanurate.
1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.
1.12. Acylaminophenols, for example 4-hydroxylauranilide, 4-hydroxystearanilide, octyl N-(3,5-di-tert-butyl-4-hydroxyphenyl)carbamate.
1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethyl-lene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.
1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, tri-ethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.17. Amides of β-(3,5-di-tert-butyl-4-hydroxyphenyl)propionic acid e.g. N,N′-bis(3,5-di-tert-butyl-4-hydroxyphenyl propionyl)hexamethylenediamide, N,N′-bis(3,5-di-tert-butyl-4-hydroxy-phenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard® XL-1, supplied by Uniroyal).
1.18. Ascorbic acid (vitamin C)
1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butyl-aminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylamino-methylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenyl-amino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyl-diphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.

### 2. UV Absorbers and Light Stabilizers

2.1. 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethyl benzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyl-oxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonyl-ethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂₂, where R=3′-tert-butyl-4′-hydroxy-5′-2H-benzotriazol-2-ylphenyl, 2-[2′-hydroxy-3′-(α,α-dimethyl benzyl)-5′-(1,1,3,3-tetramethylbutyl)-phenyl]-benzotriazole; 2-[2′-hydroxy-3′-(1,1,3,3-tetramethylbutyl)-5′-(α,α-dimethyl benzyl)-phenyl]benzotriazole.
2.2. 2-Hydroxybenzophenones, for example the 4-hydroxy, 4-methoxy, 4-octyloxy, 4-decyl-oxy, 4-dodecyloxy, 4-benzyloxy, 4,2′,4′-trihydroxy and 2′-hydroxy-4,4′-dimethoxy derivatives.
2.3. Esters of substituted and unsubstituted benzoic acids, for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.
2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate, N-(β-carbomethoxy-β-cyanovinyl)-2-methylindoline, neopentyl tetra(α-cyano-β,β-diphenylacrylate.
2.5. Nickel compounds, for example nickel complexes of 2,2′-thio-bis[4-(1,1,3,3-tetramethyl-butyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.
2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)-oxymethyl-3,3,5-trimethyl-2-morpholinone, Sanduvor (Clariant; CAS Reg. No. 106917-31-1], 5-(2-ethylhexanoyl)oxymethyl-3,3,5-trimethyl-2-morpholinone, the reaction product of 2,4-bis-[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)-amino)-s-triazine.
2.7. Oxamides, for example 4, 4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.
2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethyl-phenyl)-1,3,5-triazine, 2-(2-hydroxy-4-hexyloxy)phenyl-4,6-diphenyl-1,3,5-triazine, 2-(2-hydro-oxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine.
3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyl-oyl)oxalyl dihydrazide, N,N′-bis(salicyloyl)thiopropionyl dihydrazide.
4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo-[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

The following phosphites are especially preferred:

Tris(2,4-di-tert-butylphenyl) phosphite (Irgafos® 168, Ciba Specialty Chemicals Inc.), tris(nonylphenyl) phosphite,

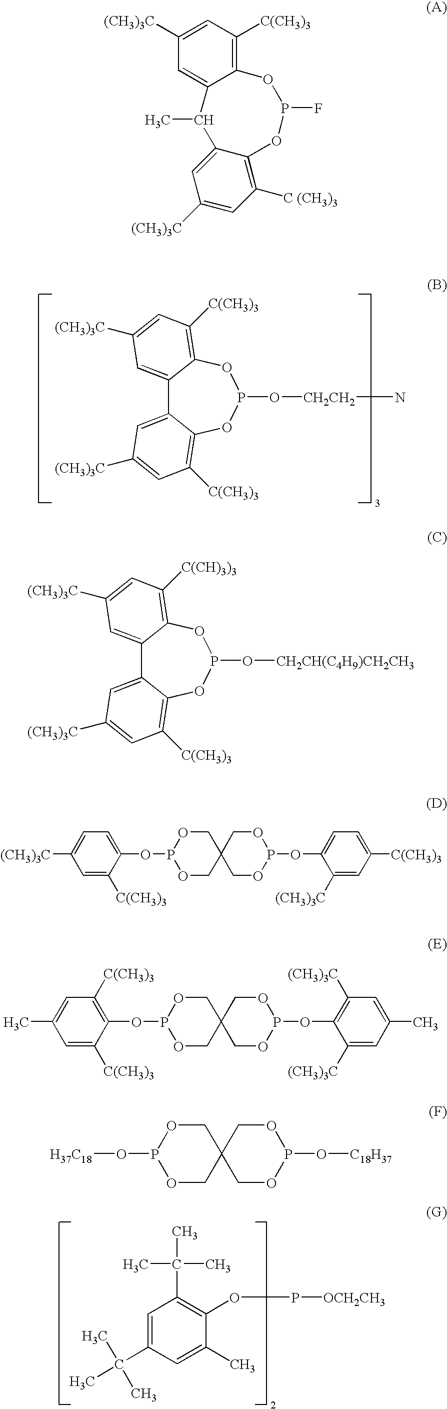

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.
6. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.
7. Thiosynergists, for example dilauryl thiodipropionate, dimistryl thiodipropionate, distearyl thiodipropionate or distearyl disulfide.
8. Peroxide scavengers, for example esters of β-thiodipropionic acid, for example the lauryl, stearyl, myristyl or tridecyl esters, mercaptobenzimidazole or the zinc salt of 2-mercapto-benzimidazole, zinc dibutyldithiocarbamate, dioctadecyl disulfide, pentaerythritol tetrakis(β-dodecylmercapto)propionate.
9. Polyamide stabilizers, for example copper salts in combination with iodides and/or phosphorus compounds and salts of divalent manganese.
10. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.
11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyl-dibenzylidene)sorbitol, and 1,3:2,4-di(benzylidene)sorbitol.
12. Fillers and reinforcing agents, for example calcium carbonate, silicates, glass fibres, glass beads, asbestos, talc, kaolin, mica, barium sulfate, metal oxides and hydroxides, carbon black, graphite, wood flour and flours or fibers of other natural products, synthetic fibers.
13. Other additives, for example plasticisers, lubricants, emulsifiers, pigments, rheology additives, catalysts, flow-control agents, optical brighteners, flameproofing agents, antistatic agents and blowing agents.
14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxy-ethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-di-methylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctyl-benzofuran-2-one.

The nature and amount of the further additives added are determined by the nature of the substrate to be stabilized and its intended use; in many cases from 0.1 to 5% by weight is used, based on the polymer to be stabilized.

The microencapsulated luminescent pigment of the invention and optional further components may be added to the polymer material individually or mixed with one another. If desired, the individual components can be mixed with one another before incorporation into the polymer for example by dry blending, compaction or in the melt.

The incorporation of the microencapsulated luminescent pigment of the invention and optional further components into the polymer is carried out by known methods such as dry blending in the form of a powder, or wet mixing in the form of solutions, dispersions or suspensions for example in an inert solvent, water or oil. The additive of the invention and optional further additives may be incorporated, for example, before or after molding or also by applying the dissolved or dispersed additive or additive mixture to the polymer material, with or without subsequent evaporation of the solvent or the suspension/dispersion agent. They may be added directly into the processing apparatus (e.g. extruders, internal mixers, etc), e.g. as a dry mixture or powder or as solution or dispersion or suspension or melt.

The incorporation can be carried out in any heatable container equipped with a stirrer, e.g. in a closed apparatus such as a kneader, mixer or stirred vessel. The incorporation is preferably carried out in an extruder or in a kneader. It is immaterial whether processing takes place in an inert atmosphere or in the presence of oxygen.

The addition of the microencapsulated luminescent pigment or additive blend to the polymer can be carried out in all customary mixing machines in which the polymer is melted and mixed with the additives. Suitable machines are known to those skilled in the art. They are predominantly mixers, kneaders and extruders.

The process is preferably carried out in an extruder by introducing the additive during processing.

Particularly preferred processing machines are single-screw extruders, contrarotating and corotating twin-screw extruders, planetary-gear extruders, ring extruders or cokneaders. It is also possible to use processing machines provided with at least one gas removal compartment to which a vacuum can be applied.

Suitable extruders and kneaders are described, for example, in Handbuch der Kunststoffextrusion, Vol. 1 Grundlagen, Editors F. Hensen, W Knappe, H. Potente, 1989, pp. 3-7, ISBN:3-446-14339-4 (Vol. 2 Extrusionsanlagen 1986, ISBN 3-446-14329-7).

For example, the screw length is 1-60 screw diameters, preferably 35-48 screw diameters. The rotational speed of the screw is preferably 10-600 rotations per minute (rpm), very particularly preferably 25-300 rpm.

The maximum throughput is dependent on the screw diameter, the rotational speed and the driving force.

If a plurality of components is added, these can be premixed or added individually. The microencapsulated luminescent pigment of the invention and optional further additives can also be sprayed onto the polymer material. They are able to dilute other additives (for example the conventional additives indicated above) or their melts so that they can be sprayed also together with these additives onto the material. Addition by spraying during the deactivation of the polymerization catalysts is particularly advantageous; in this case, the steam evolved may be used for deactivation of the catalyst. In the case of spherically polymerized polyolefins it may, for example, be advantageous to apply the microencapsulated luminescent pigment of the invention, optionally together with other additives, by spraying.

The microencapsulated luminescent pigment of the invention and optional further additives can also be added to the polymer in the form of a masterbatch (“concentrate”) which contains the components in a concentration of, for example, about 1% to about 40% and preferably 2% to about 20% by weight incorporated in a polymer. The polymer must not be necessarily of identical structure than the polymer where the additives are added finally. In such operations, the polymer can be used in the form of powder, granules, solutions, suspensions or in the form of latices.

Incorporation can take place prior to or during the shaping operation, or by applying the dissolved or dispersed compound to the polymer, with or without subsequent evaporation of the solvent. In the case of elastomers, these can also be stabilized as latices. A further possibility for incorporating the microencapsulated luminescent pigment of the invention into polymers is to add them before, during or directly after the polymerization of the corresponding monomers.

The films can be coextruded by film extrusion such as blown film extrusion or by cast film extrusion or they can be laminated and they can include layers based on polymers such as polyamide (PA 6 or 6, 6 or 11 or 12 or 6/6,6 copolymer including OPA), polyethylene terephtalate (PET including OPET), polyethylene naphtalate (PEN), ethylene vinyl alcohol (EvOH), polypropylene (including OPP), ethylene acrylic acid copolymers and their salts, ethylene methacrylic acid copolymers and their salts, or Polyvinylidenchloride (PVDC) or aluminum foil. The films can also be coated with the above polymers or silicone-based coatings (e.g. SiOx) or aluminum oxide or any other coating applied by plasma, web coating or electron-beam coating.

Another aspect of the invention is a process for enhancing plant growth, comprising exposing a plant to actinic radiation over, behind or under a polymer composition as described above. (Anspruch 20)

A further aspect of the invention is the use of a microencapsulated luminescent pigment as described above as plant growth enhancing additive in thermoplastic polymers for agricultural applications in the form of films for greenhouses and small tunnel covers, films or filaments for shading nets and screens, mulch films, non-wovens or molded articles for the protection of young plants. (Anspruch 21)

Definitions and preferences have already been given for the compositions and apply also for the process and use.

Nets can for example be used for increased ventilation (and as a barrier to insects) or for their shading and energy savings.

Nets can be manufactured in different ways. One is to cut films in small stripes which are then woven. Another possibility is to start with monofilament fibers, which are subsequently woven. A further possibility for making shading nets (also called screens) is more complex. A net is formed from woven monofilament fibers with tapes woven through this net. These tapes can be based on aluminium and/or a broad variety of polymers. In some cases, the monofilament net can be laminated on 1 or both sides with e.g. PE.

In general greenhouses and small tunnel covers are preferred. The plants, which are grown in greenhouses and small tunnel covers and the growth of which can be enhanced by the instant invention are for example flowers, legumes, fruits and crop.

Yet another aspect of the invention is the use of a microencapsulated luminescent pigment as described above as light converting additive in electric or electronic applications. (Anspruch 22)

Preferred is the use of a microencapsulated luminescent pigment as described above as light converting additive in solar cells. (Anspruch 23)

The microencapsulation described in the present invention results in the effective separation of the luminescent pigment from the surrounding environment, leading to higher emission intensities, higher visible light transmission and slower degradation rates of the pigment itself and of the overall composition. All of the above effects can be very beneficial for plant growth when the microencapsulated pigment transforms ultraviolet to red light and the microcapusles are dispersed in a thermoplastic polymeric composition used to produce films or nets to cover agricultural greenhouses or tunnels or mulching materials.

The following examples illustrate the invention.

Luminescent pigment used: Smartlight RL 1000 in powder form, available from Ciba Specialty Chemicals Inc. The product is the condensation product of barbituric acid and p-dimethylamino benzaldehyde, which is prepared as, for example, described in EP1413599.

### EXAMPLE 1

### Preparation of Microencapsulated Smartlight Pigments (Samples SL1, SL2 and SL3)

Into a 1-litre reactor equipped with a dispersing tool (dissolver stirrer), 300 ml of deionised water is charged in followed by adding 10 drops of PEG300 (polyethylene glycol 300) to the water. The contents of the reactor are warmed to 60° C. by means of a thermostatic water bath. Next, 17 g of 50% melamine formaldehyde resin (PIAMID® M50 supplied by SKW Stickstoffwerke Piesteritz) and 10 ml of 2 N amidosulfonic acid are added respectively. After 1 minute, 60 g of Smartlight RL1000 powder (luminescent pigment available from Ciba Specialty Chemicals) is added and the stirring speed increased to 1400 rpm to disperse the pigment particles. After 10 minutes dispersion, the stirrer speed is reduced to 800 rpm. Then, the resulting aqueous dispersion is maintained at 60° C. for 2 hours to complete the encapsulating of the pigment particles. The microencapsulated pigment dispersion is then allowed to cool to room temperature.

The microencapsulated Smartlight pigments are recovered by filtration, washing with water and then vacuum drying at 60° C.

The microencapsulated Smartlight particles have particle size of about 1-15 μm with shell thickness of about 50-100 nm.

### EXAMPLE 2

### Compounding of Microencapsulated Pigments

The microencapsulated Smartlight pigments of Example 1 are compounded into LDPE (Riblene FF29) with 1% Smartlight content (related to pure Smartlight). Compounding is performed in a twin-screw extruder (type Brabender DSE25/36D, co-kneading), with control of internal temperature and torque and screw configuration special designed for compounding of microcapsules. Torque is set to 150 rpm. Polyethylene and microcapsules are fed in separately applying metering devices (balance). Because of the low amount of Smartlight that was to be fed in the polyethylene melt a premix of smartlight microcapsules and polyethylene powder (screened <1 mm) is added (6.7 wt.-% Smartlight microcapsules). The initial mixture is homogenized in a turbula-mixer before application. The funnels are heat-insulated and feeding-in for polyethylene as well as Smartlight microcapsules are cooled. Addition of microcapsules into the melt of polyethylene is carried out just before discharging the compound to avoid high mechanical stress. The compound is discharged through a single-jet injection nozzle (diameter 5.7 mm) to avoid high extrusion pressure.

The compounds are granulated and air-dried for further processing and stability tests. Samples SL1-SL3 are compounded, 3 kg each. The compounds are red coloured with homogenous colour distribution and not transparent. Scanning electron microscopic investigations are carried out after cryo-rupture of granules to estimate the stability of Smartlight microcapsules in the compound.

Microencapsulated Smartlight particles are homogeneously spread in the polyethylene matrix. Agglomerates couldn't be observed. Particle size corresponds to that before compounding. Pure smartlight particles are characterised by sharp fracture edges to the polyethylene matrix. By contrast, there is a stable adhesion between microcapsule shells and polyethylene matrix.

### EXAMPLE 3

### Preparation of a LDPE Film Containing Microencapsulated Pigment

150 micron thickness LDPE films are prepared by means of a Formac Lab extruder; extrusion profile temperatures ranged between 200 and 210° C.

### Artificial Weathering Test.

The artificial weathering of the LDPE film of example 3 is performed in a Whether-O-Meter operating with a xenon lamp (emission of 0.35 W/m2 at 340 nm).

### EXAMPLE 4

### Luminescence Analysis

This example illustrates the improvement in luminescence of the LDPE film containing microencapsulated Smartlight pigment compared to unencapsulated Smartlight pigment.

Luminescence analysis is performed on the exposed films taking as a reference a LDPE film with the same formulation of other components, same thickness and same loading of pigment, with the exception that not encapsulated but commercial grade Smartlight (NESL) is used.

Encapsulated smartlight luminesces much stronger than non-encapsulated. When measured with the same instrumental parameters the ratio is about 6:1.

Table 1 shows the change in luminescence after weathering of the different encapsulated samples compared to the unencapsulated pigment.

TABLE 1
Residual luminescence of the artificial weathered LDPE films,
each relative to the initial intensity set as 100.

| Hours in WOM | 0 | 260 | 600 | 1050 |
|---|---|---|---|---|
| SL1 | 100 | 90 | 85 | 68 |
| SL2 | 100 | 84 | 79 | 71 |
| SL3 | 100 | 100 | 83 | 64 |
| NESL | 100 | 48 | 41 | 40 |

A remarkable improvement of the retained luminescence is observed during artificial weathering, compared to the not encapsulated Smartlight.

Encapsulated and non-encapsulated Smartlight-containing samples are also irradiated while being immersed in water, as an extreme check of the impact of humidity. After 288 hours in the WOM device, the sample containing encapsulated pigment is still 5 times more luminescent than the sample containing commercial grade Smartlight.

### EXAMPLE 5

### Optical Properties

This example illustrates the improvement in visible light transmission of the LDPE films containing the microencapsulated Smartlight compared to non-encapsulated Smartlight pigment.

The results are summarised in Table 2

TABLE 2
Results of optical analysis of LDPE films.

| | % T (400-700 nm) | % Haze |
|---|---|---|
| SL1 | 73.4 | 52.9 |
| SL2 | 71.2 | 54.9 |
| SL3 | 74.4 | 46.7 |
| NESL | 62.0 | 66.2 |

Visible light transmitted by LDPE films containing the capsules is improved in all cases compared to the non-encapsulated pigment.

### EXAMPLE 6

### Interaction of Other Polymer Additives

Table 3 shows the fluorescence properties of encapsulated and commercial grade Smartlight containing films in presence of co additives:
0.25% Calcium stearate (Ca St)
2.5% Serdox NXK 1000 (Serdon)
2.5% Atmer 103 (A103)
2.5% Atmer 185 (A185)
5% Polestar 200 R (caolin)

From Table 3 it can be clearly seen that the compatibility of the encapsulated Smartlight pigment with other polymer additives is significantly improved, compared to non-encapsulated Smartlight pigment.

TABLE 3
Effect of different polymer additives on LDPE films containing
encapsulated or non-encapsulated Smartlight pigment (fluorescence
in arbitrary emission units)

| | Ca St | Serdo | A103 | A185 | caolin |
|---|---|---|---|---|---|
| SL1 | 462 | 561 | 487 | 629 | 270 |
| NESL | 77 | 150 | 14 | 34 | 88 |

1. A microencapsulated luminescent pigment having an absorption maximum between 0.350 nm and 550 nm and an emission maximum between 550 nm and 700 nm with a Stokes shift equal or greater than 80 nm, wherein the shell of the microcapsule is formed from a crosslinked polymer.

2. A microencapsulated luminescent pigment according to claim 1 wherein the absorption maximum is between 350 nm and 500 nm and the emission maximum is between 600 nm and 700 nm.

3. A microencapsulated luminescent pigment according to claim 1 wherein the Stokes shift is equal to or greater than 120 nm.

4. A microencapsulated luminescent pigment according to claim 1 wherein the luminescent pigment is an organic luminescent pigment.

5. A microencapsulated luminescent pigment according to claim 1 wherein the luminescent pigment is selected from the group consisting of anthraquinones, coumarins, benzo-coumarins, xanthenes, benzo[a]xanthenes, benzo[b]xanthenes, benzo[c]xanthenes, phenoxazines, benzo[a]phenoxazines, benzo[b]phenoxazines and benzo[c]phenoxazines, napthalimides, naphtholactams, azlactones, methines, oxazines and thiazines, diketopyrrolopyrroles, perylenes, quinacridones, benzoxanthenes, thio-epindolines, lactamimides, diphenylmaleimides, acetoacetamides, imidazothiazines, benzanthrones, perylenmonoimides, perylenes, phthalimides, benzotriazoles, pyrimidines, pyrazines, triazoles, dibenzofurans, triazines and barbituric acid derivatives.

6. A microencapsulated luminescent pigment according to claim 1 wherein the luminescent pigment is selected from the group consisting of anthraquinones, oxazines, perylenes and barbituric acid derivatives.

7. A microencapsulated luminescent pigment according to claim 1 wherein the luminescent pigment is the condensation product of 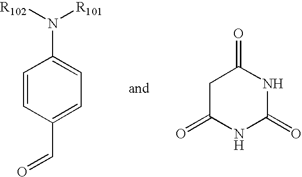
wherein R₁₀ₗ and R₁₀₂ are independently hydrogen or C₁-C₁₈ alkyl.

8. A microencapsulated luminescent pigment according to claim 1 wherein the polymer of the shell is crosslinked by in situ polymerization.

9. A microencapsulated luminescent pigment according to claim 1 wherein the crosslinked polymer of the shell is selected from the group consisting of melamine-formaldehydes, urea-formaldehydes, phenol-formaldehydes, polyamides, polyureas, polyurethane's, polyacrylates, polymethacrylates, polystyrenes, polyvinylpyridines, polyacrlonitriles, polyepoxides, gelatin, poly (vinyl alcohol), cellulose derivatives, silica and silicone resins.

10. A microencapsulated luminescent pigment according to claim 9 wherein the crosslinked polymer of the shell is selected from the group consisting of melamine-formaldehydes, urea-formaldehydes and phenol-formaldehydes.

11. A microencapsulated luminescent pigment according to claim 1, which has an average particle size of 0.8 to 50μ.

12. A microencapsulated luminescent pigment according to claim 1 wherein the weight ratio of microcapsule-forming material to microencapsulated luminescent pigment is from 0.001:1 to 1:1.

13. A microencapsulated luminescent pigment according to claim 1, which additionally contains in the microcapsule a further additive selected from the group consisting of antioxidants, phosphites or phosphonites, UV-absorbers, light stabilizers, singlet oxygen quenchers, further fluorescent dyes or pigments, processing aids, antistatic agents, antifog additives and fillers or reinforcing materials.

14. A polymer composition comprising
a) a thermoplastic, elastomeric or crosslinked polymer and
b) a microencapsulated luminescent pigment having an absorption maximum between 350 nm and 550 nm and an emission maximum between 550 nm and 700 nm with a Stokes shift equal or greater than 80 nm, wherein the shell of the microcapsule is formed from a crosslinked polymer.

15. A polymer composition according to claim 14 wherein component a) is a thermoplastic polymer.

16. A polymer composition according to claim 15 wherein the thermoplastic polymer is selected from the group consisting of a polyolefin, a polyester, a polyvinylalcohol, a polyvinylacetate and a polycarbonate.

17. A polymer composition according to claim 14, which is in the form of a film with a thickness from 10μ to 300μ.

18. A polymer composition according to claim 17 wherein the film is a multilayer construction of between 2 and 7 polymer layers containing component b) in at least 1 layer.

19. A polymer composition according to claim 14 containing an additional additive selected from the group consisting of antioxidants, phosphites or phosphonites, UV-absorbers, light stabilizers, singlet oxygen quenchers, further fluorescent dyes or pigments, processing aids, antistatic agents, antifog additives and fillers or reinforcing materials.

20. A process for enhancing plant growth, comprising exposing a plant to actinic radiation over, behind or under a polymer composition according to claim 14.

21-23. (canceled)
